(19) United States
(12) Patent Application Publication
(10) Pub. No.: US 2018/0072928 A1
(43) Pub. Date: Mar. 15, 2018

(54) HIGH PERFORMANCE (METH)ACRYLATE ADHESIVE COMPOSITION

(71) Applicant: 3M INNOVATIVE PROPERTIES COMPANY, St. Paul, MN (US)

(72) Inventors: Joon Chatterjee, Bloomington, MN (US); Raja Krishnamurthy, Bangalore (IN); Surojit Sinha, Bangalore (IN); Babu N. Gaddam, Woodbury, MN (US)

(21) Appl. No.: 15/565,265

(22) PCT Filed: May 2, 2016
(86) PCT No.: PCT/US2016/030352

§ 371 Date: Oct. 9, 2017

Related U.S. Application Data
(60) Provisional application No. 62/159,485, filed on May 11, 2015.

(51) Int. Cl. C09J 133/08; C08L 33/08; C09J 7/02

(52) U.S. Cl. CPC C09J 133/08; C08L 33/08; C09J 2425/00; C09J 2433/00; C09J 7/0217

(57) ABSTRACT

An adhesive composition is described comprising a tertiary amine- and hydroxyl-functional (meth)acrylate copolymer and a styrene/maleic anhydride crosslinking agent, which when crosslinked, provides a pressure-sensitive adhesive and pressure-sensitive adhesive articles.

### TECHNICAL FIELD OF THE INVENTION

This invention relates to pressure-sensitive adhesives and tape articles prepared therefrom. The adhesives are characterized by exhibiting an overall balance of adhesive and cohesive characteristics and exceptional load bearing capabilities at elevated temperatures.

### BACKGROUND OF THE INVENTION

Pressure-sensitive tapes are virtually ubiquitous in the home and workplace. In its simplest configuration, a pressure-sensitive tape comprises an adhesive and a backing, and the overall construction is tacky at the use temperature and adheres to a variety of substrates using only moderate pressure to form the bond. In this fashion, pressure-sensitive tapes constitute a complete, self-contained bonding system.

According to the Pressure-Sensitive Tape Council, pressure-sensitive adhesives (PSAs) are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). PSAs do not embrace compositions merely because they are sticky or adhere to a surface.

These requirements are assessed generally by means of tests which are designed to individually measure tack, adhesion (peel strength), and cohesion (shear holding power), as noted in A.V. Pocius in Adhesion and Adhesives Technology: An Introduction, 2^{nd} Ed., Hanser Gardner Publication, Cincinnati, Ohio, 2002. These measurements taken together constitute the balance of properties often used to characterize a PSA.

With broadened use of pressure-sensitive tapes over the years, performance requirements have become more demanding. Shear holding capability, for example, which originally was intended for applications supporting modest loads at room temperature, has now increased substantially for many applications in terms of operating temperature and load. So-called high performance pressure-sensitive tapes are those capable of supporting loads at elevated temperatures for 10,000 minutes. Increased shear holding capability has generally been accomplished by crosslinking the PSA, although considerable care must be exercised so that high levels of tack and adhesion are retained in order to retain the aforementioned balance of properties.

There are two major crosslinking mechanisms for acrylic adhesives: free-radical copolymerization of multifunctional ethylenically unsaturated groups with the other monomers, and covalent or ionic crosslinking through the functional monomers, such as acrylic acid. Another method is the use of UV crosslinkers, such as copolymerizable benzophenones or post-added photocrosslinkers, such as multifunctional benzophenones and triazines. In the past, a variety of different materials have been used as crosslinking agents, e.g., polyfunctional acrylates, acetophenones, benzophenones, and triazines. The foregoing crosslinking agents, however, possess certain drawbacks which include one or more of the following: high volatility; incompatibility with certain polymer systems; generation of corrosive or toxic by-products; generation of undesirable color; requirement of a separate photoactive compound to initiate the crosslinking reaction; and high sensitivity to oxygen.

### SUMMARY

Briefly, the present disclosure provides a pre-adhesive, curable composition comprising an hydroxy and tertiary amine-functional (meth)acrylate copolymer and a styrene/maleic anhydride copolymer, which when crosslinked provides a pressure-sensitive adhesive composition. More specifically, the SMA copolymer serves as a crosslinking agent for the copolymer.

The pressure-sensitive adhesives, the crosslinked compositions, of this disclosure provide the desired balance of tack, peel adhesion, and shear holding power, and further conform to the Dahlquist criteria; i.e. the modulus of the adhesive at the application temperature, typically room temperature, is less than 3×10⁶ dynes/cm² at a frequency of 1 Hz.

The use of the SMA copolymers as a crosslinking agent affords a number of advantages as compared to the use of conventional crosslinking agents for (meth)acrylic adhesives. These advantages include, but are not limited to, decreased sensitivity of the crosslinkable composition to oxygen and the avoidance of evolution of any toxic or corrosive by-products or discoloration of the final product. Furthermore, the SMA crosslinking agents have the following advantages over previously described agents: ease of synthesis, the ability to increase the T_{g} of the crosslinked adhesive compositions, compatibility with the copolymer, solubility in the component monomers or organic solvents, and low cost starting materials.

In some embodiments, this disclosure provides an adhesive composition derived from renewable resources. In particular, the present invention provides an adhesive composition derived, in part, from plant materials. In some embodiments, the present invention further provides an adhesive article, wherein the substrate or backing is also derived from renewable resources. The increase in the price of oil, and concomitant petroleum-derived products, has led to volatile prices and supply for many adhesive products. It is desirable to replace all or part of the petroleum-based feedstocks with those derived from renewable sources, such as plants, as such materials become relatively cheaper, and are therefore both economically and socially beneficial. Therefore, the need for such plant-derived materials has become increasingly significant.

In this application “pre-adhesive” refers to the solution comprising the (meth)acrylate copolymer, and SMA crosslinking agent which may be crosslinked to form a pressure-sensitive adhesive.

In this application, (meth)acrylic or (meth)acrylate is inclusive of both methacrylic and acrylic. (Meth)acryloyl is inclusive of (mth)acrylate and (meth)acrylamide.

As used herein, “alkyl” includes straight-chained, branched, and cyclic alkyl groups and includes both unsubstituted and substituted alkyl groups. Unless otherwise indicated, the alkyl groups typically contain from 1 to 20 carbon atoms. Examples of “alkyl” as used herein include, but are not limited to, methyl, ethyl, n-propyl, n-butyl, n-pentyl, isobutyl, t-butyl, isopropyl, n-octyl, n-heptyl, 2-octyl, ethylhexyl, cyclopentyl, cyclohexyl, cycloheptyl, adamantyl, and norbornyl, and the like. Unless otherwise noted, alkyl groups may be mono- or polyvalent.

As used herein, the term “heteroalkyl” includes both straight-chained, branched, and cyclic alkyl groups with one or more heteroatoms independently selected from S, O, and N with both unsubstituted and substituted alkyl groups. Unless otherwise indicated, the heteroalkyl groups typically contain from 1 to 20 carbon atoms. “Heteroalkyl” is a subset of “hydrocarbyl containing one or more S, N, O, P, or Si atoms” described below. Examples of “heteroalkyl” as used herein include, but are not limited to, methoxy, ethoxy, propoxy, 3,6-dioxaheptyl, 3-(trimethylsilyl)-propyl, 4-dimethylaminobutyl, and the like. Unless otherwise noted, heteroalkyl groups may be mono- or polyvalent.

As used herein, “aryl” is an aromatic group containing 6-18 ring atoms and can contain optional fused rings, which may be saturated, unsaturated, or aromatic. Examples of an aryl groups include phenyl, naphthyl, biphenyl, phenanthryl, and anthracyl. Heteroaryl is aryl containing 1-3 heteroatoms such as nitrogen, oxygen, or sulfur and can contain fused rings. Some examples of heteroaryl groups are pyridyl, furanyl, pyrrolyl, thienyl, thiazolyl, oxazolyl, imidazolyl, indolyl, benzofuranyl, and benzthiazolyl. Unless otherwise noted, aryl and heteroaryl groups may be mono- or polyvalent.

### DETAILED DESCRIPTION

The present disclosure provides a pre-adhesive composition comprising a tertiary amine- and hydroxyl-functional (meth)acrylate copolymer and a SMA crosslinking agent, which when crosslinked, provides a pressure-sensitive adhesive and pressure-sensitive adhesive articles.

The (meth)acrylate ester monomer useful in preparing the functional (meth)acrylate adhesive copolymer is a monomeric (meth)acrylic ester of a non-tertiary alcohol, which alcohol contains from 1 to 14 carbon atoms and preferably an average of from 4 to 12 carbon atoms.

Examples of monomers suitable for use as the (meth)acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, and the like. In some embodiments, the preferred (meth)acrylate ester monomer is the ester of (meth)acrylic acid with butyl alcohol or isooctyl alcohol, or a combination thereof, although combinations of two or more different (meth)acrylate ester monomer are suitable. In some embodiments, the preferred (meth)acrylate ester monomer is the ester of (meth)acrylic acid with an alcohol derived from a renewable source, such as 2-octanol, citronellol, dihydrocitronellol.

In some embodiments it is desirable for the (meth)acrylic acid ester monomer to include a high T_{g} monomer, have a T_{g} of at least 25° C., and preferably at least 50° C. Suitable high T_{g} monomers include Examples of suitable monomers useful in the present invention include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate or combinations.

The (meth)acrylate ester monomer is present in an amount of 85 to 99.5 parts by weight based on 100 parts total monomer content used to prepare the polymer. Preferably (meth)acrylate ester monomer is present in an amount of 90 to 95 parts by weight based on 100 parts total monomer content. When high Tg monomers are included, the copolymer may include up to 30 parts by weight, preferably up to 20 parts by weight of the 85 to 99.5 parts by weight of (meth)acrylate ester monomer component.

The (meth)acrylate copolymer comprises interpolymerized monomer units of the formula:

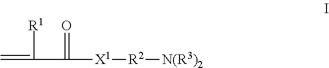

where X¹ is —O— or —NR¹—, where each R¹ is H or C₁-C₄ alkyl, preferably H or methyl; and R² is an alkylene (e.g., an alkylene having 1 to 10 carbon atoms, 1 to 6, or 1 to 4 carbon atoms) or an arylene, each R³ is independently alkyl or aryl. R² may be linear or branched and is optionally substituted with one or more in chain oxygen atoms.

Useful aminoalkyl (meth)acrylates (i.e., in Formula II is oxy) include diialkylaminoalkyl(meth)acrylates such as, for example, dimethylaminoethylmethacrylate, dimethylaminoethylacrylate, diethylaminoethylmethacylate, diethylaminoethylacrylate, dimethylaminopropylmethacrylate, dimethylaminopropylacrylate, methylbutylaminopropylmethacrylate, ethylbutylaminopropylacrylate, diphenylaminoethyl acrylate, and the like.

Exemplary amino (meth)acrylamides (i.e., X¹ in Formula II is —NR¹—) include, for example, 3-(dimethylamino)propylmethacrylamide, 3-(diethylamino)propylmethacrylamide, 3-(ethylmethylamino)propylmethacrylamide diphenylaminoethylacrylamide, and the like.

The amino (meth)acrylamides and (meth)acrylates are used in amounts of 0.1 to 10 parts by weight, relative to 100 parts by weight total monomer.

The (meth)acrylate copolymer includes interpolymerized monomer units of a hydroxy-functional (meth)acrylate monomer of the formula:

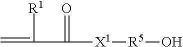

where X¹ is —O— or —NR¹—, where each R¹ is H or C₁-C₄ alkyl, preferably H or methyl; and R⁵ is an alkylene (e.g., an alkylene having 1 to 10 carbon atoms, 1 to 6, or 1 to 4 carbon atoms) or an arylene. When R⁵ is alkylene, the alkylene may be linear or branched and optionally substituted with one or more in-chain oxygen atoms.

Useful hydroxyalkyl (meth)acrylates include mono acrylate and methacrylate esters of aromatic (aryl) diol and aliphatic diols. Useful aromatic diols include 1,4-benzenedimethanol; bisphenol A; ring-opened bisphenol A diglycidal ether, 1,3-bis(2-hydroxyethoxy)benzene; and combinations thereof. Useful aliphatic diols include 1,6-hexanediol; 1,4-butanediol; trimethylolpropane; 1,4-cyclohexanedimethanol; neopentyl glycol; ethylene glycol; propylene glycol; polyethylene glycol; tricyclodecanediol; norbornane diol; bicyclo-octanediol; pentaerythritol; and combinations thereof

The hydroxyalkyl (meth)acryloyl monomers are used in amounts of 0.1 to 10 parts by weight, relative to 100 parts total monomer in the copolymer.

The copolymer generally does not comprise acid-functional monomer units such as (meth)acrylic acid.

The functional (meth)acrylate copolymers may be prepared by solution methods. A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 20 hours, depending upon the batch size and temperature. Examples of the solvent are methanol, tetrahydrofuran, ethanol, isopropanol, acetone, methyl ethyl ketone, methyl acetate, ethyl acetate, toluene, xylene, and an ethylene glycol alkyl ether. Those solvents can be used alone or as mixtures thereof.

Suitable thermal initiators include but are not limited to those selected from the group consisting of azo compounds such as VAZO™ 64 (2,2′-azobis(isobutyronitrile)), VAZO™ 67 (2,2′azobis (2-methylbutyronitrile)), and VAZO™ 52 (2,2′-azobis(2,4-dimethylpentanenitrile)), available from E.I. du Pont de Nemours Co., peroxides such as benzoyl peroxide and lauroyl peroxide, and mixtures thereof. The preferred oil-soluble thermal initiator is 2,2′-azobis-(2,4-dimethylpentanenitrile).

Alternatively, the monomer mixture may be polymerized using a photoinitiator. Useful photoinitiators include benzoin ethers such as benzoin methyl ether and benzoin isopropyl ether; substituted acetophenones such as 2,2-dimethoxyacetophenone, available as Irgacure™ 651 photoinitiator (Ciba Specialty Chemicals), 2,2 dimethoxy-2-phenyl-1-phenylethanone, available as Esacure™ KB-1 photoinitiator (Sartomer Co.; West Chester, Pa.), and dimethoxyhydroxyacetophenone; substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Particularly preferred among these are the substituted acetophenones.

The functional (meth)acrylic copolymer may be represented as

˜[M^{ester}]ₐ-[M^{OH}]_{b}-[M^{Amine}]_{c}˜, where

[M^{ester}] represents interpolymerized (meth)acrylate ester monomer units and subscript a is the parts thereof
[M^{OH}] represents interpolymerized hydroxylalkyl (meth)acrylate monomer units and subscript b is the parts thereof
[M^{Amine}] represents interpolymerized tertiary amine (meth)acrylate monomer units and subscript c is the parts thereof, where the sum of the subscripts is 100 parts by weight.

Generally the molecular weight of the styrene-maleic anhydride 1000 to 20000, preferably 1500 to 15000. In most embodiments, the styrence/maleic anhydride copolymer comprises 5 to 50 wt. % of maleic anhydride. Styrene/maleic anhydride copolymers are known.

SMA copolymers may also be prepared from free radical polymerization of styrene and maleic anhydride. Styrene or substituted styrene monomer may be used. For instance, there may be used α-methylstyrene, or styrene that is further optionally substituted in the benzene ring of the styrene moiety. The styrene may be further optionally substituted by alkyl groups having up to 18 carbon atoms, preferably up to 6 carbon atoms. Useful styrenes include styrene, α-methylstyrene, 4-tert-butylstyrene, 2-methylstyrene, 3-methylstyrene, or 4-methyl styrene;

Styrene-maleic anhydride copolymers (SMA) are commercially available with maleic anhydride contents up to 50 mol % from Polyscope Polymers under the tradename Xiran, Sartomer under the tradename SMA, and Nova Chemicals under the tradename Dylark.
1. It is believed that the composition crosslinks by condensation of the pendent hydroxy groups of the copolymer to the anhydride group as shown below. It has been found that the rate of condensation of the hydroxyl groups is slow in the absence of the pendent tertiary amine groups, and requires higher temperatures and extended reaction times. It has been found that the pre-adhesive solution is shelf-stable up to a month and does not crosslink and gel. Once coated and dried, and the crosslinking rapidly occurs. As illustrated, the hydroxyl adds to the maleic anhydride to form a half ester as catalyzed by the tertiary amine. The incipient carboxylic acid group may form ionic crosslinks between the polymer chains, or may subsequently condense with another hydroxyl group to form additional ester crosslinks, again catalyzed by the tertiary amine. Generally the molar ratio of hydroxy groups to anhydride groups is from 1:1 to 1:20.

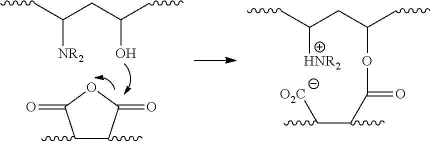

The pre-adhesive may be prepared by blending the functional copolymer and SMA in a suitable solvent. In some embodiments the SMA may be added to the reaction product solution of the functional copolymer. It is preferable to coat the adhesive composition soon after preparation. The adhesive polymer coating composition, (containing the copolymer, and crosslinking agent and solvent) are easily coated upon suitable substrates, such as flexible backing materials, by conventional coating techniques, and cured or dried, to produce adhesive coated sheet materials. The flexible backing material may be any material conventionally utilized as a tape backing, optical film or any other flexible material.

Examples of materials that can be included in the flexible backing include polyolefins such as polyethylene, polypropylene (including isotactic polypropylene), polystyrene, polyester, polyvinyl alcohol, poly(ethylene terephthalate), poly(butylene terephthalate), poly(caprolactam), poly(vinylidene fluoride), polylactides, cellulose acetate, and ethyl cellulose and the like. Commercially available backing materials useful in the invention include kraft paper (available from Monadnock Paper, Inc.); cellophane (available from Flexel Corp.); spun-bond poly(ethylene) and poly(propylene), such as Tyvek™ and Typar™ (available from DuPont, Inc.); and porous films obtained from poly(ethylene) and poly(propylene), such as Teslin™ (available from PPG Industries, Inc.), and Cellguard™ (available from Hoechst-Celanese).

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metallized polymer films, or ceramic sheet materials may take the form of any article conventionally known to be utilized with pressure-sensitive adhesive compositions such as labels, tapes, signs, covers, marking indicia, and the like.

Polymeric foams can be selected to optimize tape properties such as conformability and resiliency, which are useful when the tape is to be adhered to surfaces having surface irregularities, e.g., painted wallboard. Conformable and resilient polymeric foams are well suited for applications in which the adhesive tape is to be adhered to surfaces having surface irregularities. Such is the case with a typical wall surface. Polymeric foam layers for use in the backing generally will have a density of about 2 to about 30 pounds per cubic foot (about 32 to about 481 kg/m.sup.3), particularly in tape constructions where the foam is to be stretched to effect debonding. Where only one polymeric film or foam layer of a multi-layer backing is intended to be stretched to effect debonding, that layer should exhibit sufficient physical properties and be of a sufficient thickness to achieve that objective.

Polymeric films may be used to increase load bearing strength and rupture strength of the tape. Films are particularly well suited to applications involving adhering smooth surfaces together. A polymeric film layer typically has a thickness of about 10 micrometers (0.4 mil) to about 254 micrometers (10 mils).

The backing can include an elastomeric material. Suitable elastomeric backing materials include, e.g., styrene-butadiene copolymer, polychloroprene (i.e., neoprene), nitrile rubber, butyl rubber, polysulfide rubber, cis-1,4-polyisoprene, ethylene-propylene terpolymers (e.g., EPDM rubber), silicone rubber, silicone elastomers such as silicone polyurea block copolymers, polyurethane rubber, polyisobutylene, natural rubber, acrylate rubber, thermoplastic rubbers, e.g., styrene-butadiene block copolymers and styrene-isoprene-styrene block copolymers, and thermoplastic polyolefin rubber materials. Because of the potential difficulties of retaining optical clarity and extensibility in a multilayer construction, in many embodiments the pressure sensitive adhesive film is a single layer construction.

The flexible support may also comprise a release-coated substrate. Such substrates are typically employed when an adhesive transfer tape is provided. Examples of release-coated substrates are well known in the art and include, by way of example, silicone-coated kraft paper and the like. Tapes of the invention may also incorporate a low adhesion backsize (LAB) which are known in the art.

In some embodiments the adhesive composition may include filler. Such compositions may include at least 10 wt-%, based on the total weight of the composition. In some embodiments the total amount of filler is at most 90 wt-%. Fillers may be selected from one or more of a wide variety of materials, as known in the art, and include organic and inorganic filler. Inorganic filler particles include silica, submicron silica, zirconia, submicron zirconia, and non-vitreous microparticles of the type described in U.S. Pat. No. 4,503,169 (Randklev).

Filler components include nanosized silica particles, nanosized metal oxide particles, and combinations thereof. Nanofillers are also described in U.S. Pat. No. 7,090,721 (Craig et al.), U.S. Pat. No. 7,090,722 (Budd et al.), U.S. Pat. No. 7,156,911 (Kangas et al.), and U.S. 7,649,029 (Kolb et al.).

Fillers may be either particulate or fibrous in nature. Particulate fillers may generally be defined as having a length to width ratio, or aspect ratio, of 20:1 or less, and more commonly 10:1 or less. Fibers can be defined as having aspect ratios greater than 20:1, or more commonly greater than 100:1. The shape of the particles can vary, ranging from spherical to ellipsoidal, or more planar such as flakes or discs. The macroscopic properties can be highly dependent on the shape of the filler particles, in particular the uniformity of the shape.

In some embodiments, the composition preferably comprise a nanoscopic particulate filler (i.e., a filler that comprises nanoparticles) having an average primary particle size of less than about 100 nanometers (i.e., microns), and more preferably less than 75 nanometers.

In some embodiments, the pressure-sensitive adhesive may further comprise a tackifier. If tackifiers are used, then up to about 50% by weight, preferably less than 30% by weight, and more preferably less than 5% by weight based on the dry weight of the total adhesive polymer would be suitable. In some embodiments no tackifiers may be used. Suitable tackifiers for use with (meth)acrylate polymer dispersions include rosin acids, rosin esters, terpene phenolic resins, hydrocarbon resins, and cumarone indene resins. The type and amount of tackifier can affect properties such as contactability, bonding range, bond strength, heat resistance and specific adhesion.

If desired, the compositions can contain additives such as indicators, dyes, pigments, inhibitors, accelerators, viscosity modifiers, wetting agents, buffering agents, radical and stabilizers, and other similar ingredients that will be apparent to those skilled in the art.

The above-described compositions are coated on a substrate using conventional coating techniques modified as appropriate to the particular substrate. For example, these compositions can be applied to a variety of solid substrates by methods such as roller coating, flow coating, dip coating, spin coating, spray coating knife coating, and die coating. These various methods of coating allow the compositions to be placed on the substrate at variable thicknesses thus allowing a wider range of use of the compositions. Coating thicknesses may vary. The solutions may be of any desirable concentration, and degree of conversion, for subsequent coating, but is typically between 20 to 70 wt. % polymer solids, and more typically between 30 and 50 wt. % solids, in solvent. The desired concentration may be achieved by further dilution of the coating composition, or by partial drying.

### EXAMPLES

TABLE 1
Materials

| Designation | Description | Source |
|---|---|---|
| DMAEA | Dimethylaminoethyl acrylate | Sigma-Aldrich Chemical |
| | | Co., St. Louis, MO |
| BA | Butyl acrylate | Sigma-Aldrich Chemical |
| | | Co., St. Louis, MO |
| IBoA | Isobornyl acrylate | Sigma-Aldrich Chemical |
| | | Co., St. Louis, MO |
| HBA | 4-Hydroxybutyl acrylate | Sigma-Aldrich Chemical |
| | | Co., St. Louis, MO |
| EtAc | Ethyl acetate | Omnisolv, Billerica, MA |
| IRG651 | 2,2-Dimethoxy-1,2- | BASF, Florham, NJ |
| | diphenylethan-1-one, | |
| | available from BASF | |
| | under the trade designation | |
| | “IRGACURE 651” | |
| KB-1 | 2,2-Dimethoxy-2-phenyl-1- | Sartomer Co., West |
| | phenylethanone, available | Chester, PA |
| | from Sartomer under the trade | |
| | designation “ESACURE | |
| | KB-1 PHOTOINITIATOR” | |
| PET film | A primed poly(ethylene | Mitsubishi Film, |
| | terephthalate) film, ~2 mil | Greer, SC |
| | (~51 micrometer) thick, | |
| | available from Mitsubishi | |
| | Film under the trade | |
| | designation “MITSUBISHI | |
| | 3SAB” | |
| SMA | Copolymer of styrene and | Polyscope, Geleen, |
| | maleic anhydride, M_{W} | Netherlands |
| | 10,000, ratio of styrene: | |
| | maleic anhydride = 75/25, | |
| | available from Polyscope | |
| | under the trade designation | |
| | “XIRAN SZ 25010” | |
| THF | Tetrahydrofuran | Omnisolv, Billerica, MA |

### Test Methods

### 180° Peel Adhesion Test

Peel adhesion strength was measured at a 180° angle using an IMASS SP-200 slip/peel tester (available from IMASS, Inc., Accord Mass.) at a peel rate of 305 mm/minute (12 inches/minute). Sample tapes were laminated and attached on a substrate panel made of stainless steel. Test panels were prepared by wiping the substrate panels with a tissue wetted with 2-propanol, using heavy hand pressure to wipe the panel 8 to 10 times. This procedure was repeated two more times with clean tissues wetted with solvent. The cleaned panel was allowed to air dry for 30 minutes. Tape test samples measuring 1.27 cm by 20 cm (½ in.×8 in.) were rolled down onto the cleaned panel with a 2.0 kg (4.5 lbs.) rubber roller using 2 passes. The prepared samples were stored at 23° C./50% relative humidity for different periods of aging times (typically 1 h) before testing. The peel strength values were the average result of 3 to 5 repeated experiments. Failure mode was noted: “clean” mode indicated that the tape did not leave any visually observed residue, and the test panel looked clean; “shadow” indicated that the adhesive left some visually observed residue.

### Shear Holding Power Test

Shear holding power (or static shear strength) was evaluated at 23° C./50% RH (relative humidity) using 1 Kg load. Tape test samples measuring 1.27 cm×15.24 cm (½ in.×6 in.) were adhered to 1.5 inch by 2 inch (1.27 cm×5 cm) stainless steel (SS) panels using the method to clean the panel and attach the tape described in the peel adhesion test. The tape overlapped the panel by 1.27 cm by 2.54 cm (0.5 inch by 1 inch), and the strip was folded over itself on the adhesive side, and then folded again. A hook was hung in the second fold and secured by stapling the tape above the hook. The weight was attached to the hook and the panels were hung in a 23° C./50% RH room. The time to failure in minutes was recorded. If no failure was observed after 10,000 minutes, the test was stopped and a value of 10,000+ minutes was recorded. The modes of failure were recorded, according to visual inspection. If there was adhesive residue on the SS test panel as well as on the backing, then a “cohesive” failure was recorded. If the adhesive remained attached on the backing, then the failure was recorded as an “adhesive” failure.

### Preparative Example 1 (PE-1): Preparation of a 10 wt. % Solution of Styrene Maleic Anhydride Macromer (SMA)

A 10 g portion of solid SMA macromer (solid, used as received from the vendor) and 90 g of THF were placed inside a glass jar, and vigorously shaken (for ˜2-3 hours) at ambient temperature until a clear transparent solution (PE-1) was formed. The concentration of the PE-1 solution was thus 10% by weight solids (SMA).

### Preparative Example 2 (PE-2): Preparation of BA/DMAEA/HBA Polymer Solution

A 47 g portion of BA monomer, 1.5 g of DMAEA, 1.5 g of HBA, 0.05 g of KB-1, 75 g of EtAc were added inside a transparent glass jar (500 ml size). The mixture was shaken vigorously by a shaker for 10 minutes to form a homogeneous solution. Nitrogen gas was bubbled through this solution for 10 minutes. The glass jar was tightly sealed and placed on a roller and allowed to rotate slowly for 2 hours, during which the glass jar was exposed to UV lights (SYLVANIA 35 BLACKLIGHT, Osram Sylvania Inc, Danvers, Mass.). After that period of UV exposure, the lid of the jar was opened, terminating the polymerization. The polymer solution thus obtained was referred as PE-2.

For the amount of each component as parts per hundred (“pph”) of the total weight of monomers in the solution, see Table 2.

### Preparative Example 3 (PE-3): Preparation of BA/DMAEA Polymer Solution

A 47.5 g portion of BA monomer, 2.5 g of DMAEA, 0.05 g of KB-1, and 75 g of EtAc were added inside a transparent glass jar (500 ml size). The mixture was shaken vigorously by a shaker for 10 minutes to form a homogeneous solution. Nitrogen gas was bubbled through this solution for 10 minutes. The glass jar was tightly sealed and placed on a roller and allowed to rotate slowly for 2 hours, during which the glass jar was exposed to UV lights (SYLVANIA 35 BLACKLIGHT). After that period of UV exposure, the lid of the jar was opened, terminating the polymerization. The polymer solution thus obtained was referred as PE-3 (see Table 2).

### Preparative Example 4 (PE-4): Preparation of BA/HBA Polymer Solution

A 47.5 g portion of BA monomer, 2.5 g of HBA, 0.05 g of KB-1, and 75 g of EtAc were added inside a transparent glass jar (500 ml size). The mixture was shaken vigorously by a shaker for 10 minutes to form a homogeneous solution. Nitrogen gas was bubbled through this solution for 10 minutes. The glass jar was tightly sealed and placed on a roller and allowed to rotate slowly for 2 hours, during which the glass jar was exposed to UV lights (SYLVANIA 35 BLACKLIGHT). After that period of UV exposure, the lid of the jar was opened, terminating the polymerization. The polymer solution thus obtained was referred as PE-4 (see Table 2).

TABLE 2

| | BA, | DMAEA, | HBA, | KB-1, | EtAc, |
|---|---|---|---|---|---|
| Sample | pph | pph | pph | pph | pph |
| PE-2 | 94 | 3 | 3 | 0.1 | 150 |
| PE-3 | 95 | 5 | 0 | 0.1 | 150 |
| PE-4 | 95 | 0 | 5 | 0.1 | 150 |

### Examples 1 to 7 (EX-1 to EX-7): Curable Compositions and Pressure-Sensitive Adhesives

Amounts of PE-1, PE-2, and additional EtAc were added into a glass jar and mixed on rollers for 12 hours, forming a transparent, colorless solution. The amount of additional EtAc was calculated such that the final concentration of solution mixture was 20 weight percent (“wt. %”) solids. For each of EX-1 to EX-7, the weight percentages of PE-2 base polymer solids and PE-1 SMA solids were systematically changed as listed in Table 3.

TABLE 3

| | PE-2 | | | | Shear holding |
|---|---|---|---|---|---|
| | (BA/DMAEA/HBA) | PE-1 (SMA) | 180° peel adhesion | | power |
| Examples | Wt. % solids | Wt. % solids | oz/in (N/dm) | failure mode | minutes |
| EX-1 | 99.6 | 0.4 | 34 (31) | clean | 10000+ |
| EX-2 | 99.4 | 0.6 | 25 (23) | clean | 10000+ |
| EX-3 | 99 | 1 | 21 (19) | clean | 10000+ |
| EX-4 | 98 | 2 | 14 (13) | clean | Not measured |
| EX-5 | 97 | 3 | 3 (3) | clean | Not measured |
| EX-6 | 96 | 4 | 2 (2) | clean | 10000+ |
| EX-7 | 92 | 8 | 1 (1) | clean | 10000+ |

For EX-1 to EX-7, the solutions were each coated onto PET film (MITSUBISHI 3 SAB) using a knife coater with a gap of 20 mils (˜510 micrometers), and then dried at 80° C. for 15 minutes. The thickness of each of the dried PSA coatings was ˜2 mils (˜51 micrometers). The dried coatings were clear and colorless. The 180° peel adhesion and shear holding power values for the dried coatings of EX-1 to EX-7 were measured according the test methods described above, with results as summarized in Table 3.

### Comparative Examples

Amounts of PE-1, PE-3, and additional EtAc were added into a glass jar and mixed on rollers for several hours. The amount of additional EtAc was calculated such that the final concentration of solution mixture was 20 wt. % solids. The solutions were transparent, and DMEAE was thought to perhaps be serving as a compatibilizer. For each of CE-1 to CE-4, the weight percentages of PE-3 base polymer solids and PE-1 SMA solids were systematically changed as listed in Table 4.

TABLE 4

| | PE-3 (BA/ | PE-1 | 180° peel | | Shear | |
|---|---|---|---|---|---|---|
| Compar- | DMAEA) | (SMA) | adhesion | | holding power | |
| ative | Wt. % | Wt. % | oz/in | failure | min- | failure |
| Examples | solids | solids | (N/dm) | mode | utes | mode |
| CE-1 | 96 | 4 | 69 (63) | 2- | 7 | cohesive |
| | | | | bond | | |
| CE-2 | 94 | 6 | 43 (39) | clean | 25 | cohesive |
| CE-3 | 92 | 8 | 42 (38) | clean | 72 | cohesive |
| CE-4 | 90 | 10 | 35 (32) | clean | 152 | cohesive |

For CE-1 to CE-4, the solutions were each coated onto PET film (MITSUBISHI 3 SAB) using a knife coater with a gap of 20 mils (˜510 micrometers), and then dried at 80° C. for 15 minutes. The dried coatings were transparent, and DMEAE was thought to perhaps be serving as a compatibilizer. The thickness of each of the dried PSA coatings was ˜2 mils (˜51 micrometers). The 180° peel adhesion and shear holding power values for comparative examples CE-1 to CE-4 were measured according the test methods described above, with results as summarized in Table 3. From these results, it appeared that lack of HBA may have played a role in the reduced shear holding power evident in CE-1 to CE-4.

For comparative examples CE-5 to CE-10, amounts of PE-1, PE-4, and additional EtAc were added into a glass jar and mixed on rollers for 12 hours to form solutions. The amount of additional EtAc was calculated such that the final concentration of solution mixture was 20 wt. % solids. The solutions that formed were hazy. For each of CE-5 to CE-10, the weight percentages of PE-4 base polymer solids and PE-1 SMA solids were systematically changed as listed in Table 5.

TABLE 5

| | PE-4 | PE-1 | | | |
|---|---|---|---|---|---|
| | (BA/HBA) | (SMA) | 180° peel adhesion | | Shear holding |
| Comparative | Wt. % | Wt. % | oz/in | failure | power |
| Examples | solids | solids | (N/dm) | mode | minutes |
| CE-5 | 99 | 1 | 78 (71) | clean | 24 |
| CE-6 | 98 | 2 | 50 (46) | clean | 129 |
| CE-7 | 97 | 3 | 36 (33) | clean | 490 |
| CE-8 | 96 | 4 | 58 (53) | clean | 240 |
| CE-9 | 94 | 6 | 17 (16) | clean | 10000+ |
| CE-10 | 92 | 8 | 52 (48) | clean | 10000+ |

Each of the hazy solutions of CE-5 to CE-10 were coated onto PET film (MITSUBISHI 3SAB) using a knife coater with a gap of 20 mils (˜510 micrometers). For CE-5, CE-6, CE-7, CE-8, and CE-10 (but not CE-9), the coated films were heated for 15 min at 80° C., resulting in dried coatings. The dried coatings were hazy. CE-9 was treated differently, being subjected to a longer heating cycle of 4 hours at 80° C., resulting in a dried coating that was hazy. The 180° peel adhesion and shear holding power values for comparative examples CE-5 to CE-10 were measured according the test methods described above, with results as summarized in Table 4.

From comparative examples CE-5 to CE-10, it was evident that without the inclusion of DMAEA, the solutions of BA/HBA and SMA were hazy, as were the dried coatings. Additionally, when DMAEA was absent, additional SMA and/or thermal energy appeared to be important for improved shear holding power of the dried coatings (see, for example, CE-9 and CE-10), possibly by improving cross-linking in the dried coatings

1. A curable composition comprising:
a) a styrene-maleic anhydride copolymer, and
b) a (meth)acrylate copolymer having pendent hydroxyl groups and pendent tertiary amine groups.

2. The curable composition of claim 1 where the styrene-maleic anhydride copolymer is 5 to 50 wt. % maleic anhydride.

3. The curable composition of claim 1 wherein the styrene-maleic anhydride copolymer has an Mw of 1000 to 20000.

4. The curable composition of claim 1 wherein the (meth)acrylate copolymer comprises interpolymerized hydroxyalkyl (meth)acrylate monomer units.

5. The curable composition of claim 4 wherein the hydroxyalkyl (meth)acrylate monomer units are derived from monomers of the formula: 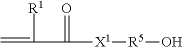
where X¹ is —O— or —NR¹—, where each R¹ is H or C₁-C₄ alkyl, and R⁵ is an alkylene or an arylene.

6. The curable composition of claim 1 wherein the (meth)acrylate copolymer comprises interpolymerized tertiary aminoalkyl (meth)acrylate monomer units.

7. The curable composition of claim 6 wherein the (tertiary aminoalkyl (meth)acrylate monomer units are derived from monomers of the formula: 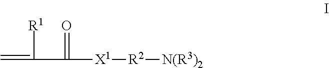
where X¹ is —O— or —NR¹—, where each R¹ is H or C₁-C₄ alkyl, and R² is an alkylene or an arylene, each R³ is independently alkyl or aryl.

8. The curable composition of claim 1 wherein (meth)acrylate copolymer comprises:
a) 80-95 parts by weight of acrylate ester monomer units,
b) 0.1 to 10 parts by weight of hydroxyalkyl (meth)acrylate monomer units; and
c) 0.1 to 10 parts by weight of tertiary aminoalkyl (meth)acrylate monomer units;
d) the sum of a) to c) being 100 parts by weight.

9. The curable composition of claim 1 comprising:
a) 0.1 to 10 parts by weight the styrene-maleic anhydride copolymer, and
b) 99.9 to 90 parts by weight of the (meth)acrylate copolymer having pendent hydroxyl groups and pendent tertiary amine groups.

10. The curable composition of claim 1 wherein the molar ratio of hydroxy groups to anhydride groups is from 1:1 to 1:20.

11. A pressure-sensitive adhesive comprising the cured composition of claims 1-10.

12. The pressure sensitive adhesive of claim 11 having a T_{g} of −50 to 5° C.

13. The pressure sensitive adhesive of claim 10 further comprising a tackifier.

14. The pressure sensitive adhesive of claim 10 further comprising a particulate filler.

15. An adhesive article comprising a layer of the pressure sensitive adhesive of claim 11 on a backing.
